(19) United States
(12) Patent Application Publication
(10) Pub. No.: US 2018/0285575 A1
(43) Pub. Date: Oct. 4, 2018

(54) DATA CRYPTOGRAPHY ENGINE

(71) Applicant: Hewlett-Packard Development Company, L.P., Fort Collins, CO (US)

(72) Inventors: Tadeu Marchese, Porto Alegre (BR); Christian Perone, Porto Alegre (BR); Diego Medaglia, Porto Alegre (BR); Wagston Staehler, Porto Alegre (BR)

(21) Appl. No.: 15/764,803

(22) PCT Filed: Jan. 21, 2016
(86) PCT No.: PCT/US2016/014317

§ 371 Date: Mar. 29, 2018

(51) Int. Cl. G06F 21/60; G06F 21/76; G06F 12/14

(52) U.S. Cl. CPC G06F 21/602; G06F 2212/1052; G06F 12/1408; G06F 21/76

(57) ABSTRACT

Examples include a system comprising a processing resource and a memory resource. Examples include a cryptography engine arranged in-line with the processing resource and the memory resource. The cryptography engine is to selectively decrypt data during read accesses of the memory resource by the processing resource.

### BACKGROUND

For systems, such as personal computers, portable computing devices, servers, etc., various types of memory resources may be implemented for different purposes. In memory resources, sensitive data may be encrypted to facilitate security of sensitive data.

### DRAWINGS

FIG. 1 is a block diagram of an example system that may make use of the disclosure.

FIG. 2 is a block diagram of an example system that may make use of the disclosure.

FIG. 3 is a block diagram of some components of an example system.

FIG. 4 is a flowchart that illustrates an example sequence of operations that may be performed by an example system.

FIG. 5 is a flowchart that illustrates an example sequence of operations that may be performed by an example system.

FIG. 6 is a flowchart that illustrates an example sequence of operations that may be performed by an example system.

FIG. 7 is a flowchart that illustrates an example sequence of operations that may be performed by an example system.

FIG. 8 is a block diagram that illustrates an example operation of some components of an example system.

FIG. 9 is a block diagram that illustrates an example operation of some components of an example system.

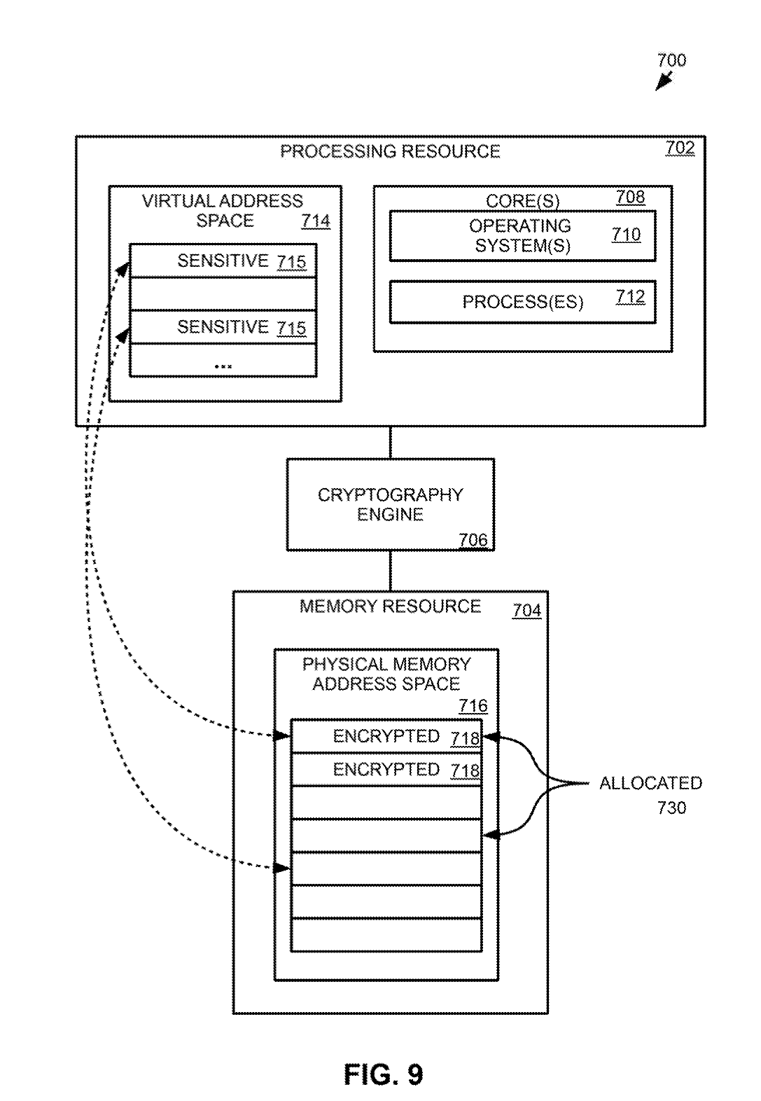

Throughout the drawings, identical reference numbers designate similar, but not necessarily identical, elements. Moreover the drawings provide examples and/or implementations consistent with the description; however, the description is not limited to the examples and/or implementations provided in the drawings.

### DESCRIPTION

Example computing systems may comprise at least one processing resource, a memory resource, and a cryptography engine connected between the processing resource and the memory resource. In such examples, the cryptography engine may be described as “in-line” with the processing resource and the memory resource. A computing system, as used herein, may include, for example, a personal computer, a portable computing device (e.g., laptop, tablet computer, smartphone), a server, blades of a server, a processing node of a server, a system-on-a-chip (SOC) computing device, a processing node of a SOC device, a smart device, and/or other such computing devices/systems. As used herein, a computing system may be referred to as simply a system.

In some example systems, a cryptography engine may be arranged in-line with a processing resource and a memory resource such that data communicated between the processing resource and the memory resource passes through and may be operated on by the cryptography engine. For example, the cryptography engine may selectively decrypt data during read accesses of the memory resource by the processing resource. As another example, the cryptography engine may selectively encrypt data during write accesses of the memory resource by the processing resource. As will be appreciated, selective encryption and decryption refers to the cryptography engine encrypting/decrypting some data while not encrypting/decrypting other data. Accordingly, in some examples, the system determines whether to encrypt/decrypt data for respective memory accesses. Examples provided herein may implement various types of cryptography/cryptosystems to encrypt/decrypt data. Some example types of cryptography/cryptosystems that may be implemented include Advanced Encryption Standard (AES) encryption. Triple Data Encryption Standard (DES), RSA cryptosystem, Blowfish cryptosystem, Twofish cryptosystem, Digital Signature Algorithm (DSA) cryptosystem, ELGamal cryptosystem, Elliptic cryptosystem, NTRUEncrypt, Rivest Cipher 4 cryptosystem, Tiny Encryption Algorithm (TEA) cryptosystem, International Data Encryption Algorithm (IDEA) cryptosystem.

Furthermore, as described herein, examples may include various engines, such as a cryptography engine. Engines, as used herein, may be any combination of hardware and programming to implement the functionalities of the respective engines. In some examples described herein, the combinations of hardware and programming may be implemented in a number of different ways. For example, the programming for the engines may be processor executable instructions stored on a non-transitory machine-readable storage medium and the hardware for the engines may include a processing resource to process and execute those instructions. In some examples, a system implementing such engines may include the machine-readable storage medium storing the instructions and the processing resource to process the instructions, or the machine-readable storage medium may be separately stored and accessible by the system and the processing resource. In some examples, engines may be implemented in circuitry. Moreover, processing resources used to implement engines may comprise at least one central processing unit (CPU), a graphics processing unit (GPU), an application specific integrated circuit (ASIC), a specialized controller (e.g., a memory controller) and/or other such types of logical components that may be implemented for data processing.

In the examples described herein, a processing resource may include at least one hardware-based processor. Furthermore, the processing resource may include one processor or multiple processors, where the processors may be configured in a single system or distributed across multiple systems connected locally and/or remotely. As will be appreciated, a processing resource may comprise one or more general purpose data processors and/or one or more specialized data processors. For example, the processing resource may comprise a central processing unit (CPU), a graphics processing unit (GPU), an application-specific integrated circuit (ASIC), and/or other such configurations of logical components for data processing. In some examples, the processing resource comprises a plurality of computing cores that may process/execute instructions in parallel, synchronously, concurrently, in an interleaved manner, and/or in other such instruction execution arrangements.

Example memory resources described herein may comprise various types of volatile and/or non-volatile memory. Examples of volatile memory may comprise various types of random access memory (RAM) (e.g., SRAM, DRAM, DDR SDRAM, T-RAM, Z-RAM), as well as other memory devices/modules that lose stored information when powered off. Examples of non-volatile memory (NVM) may comprise read-only memory (ROM) (e.g., Mask ROM, PROM, EPROM, EEPROM, etc.), flash memory, solid-state memory, non-volatile state RAM (nvSRAM), battery-backed static RAM, ferroelectric RAM (FRAM), magnetoresistive RAM (MRAM), phase-change memory (PCM), magnetic tape, optical drive, hard disk drive, 3D cross-point memory (3D XPoint), programmable metallization cell (PCM) memory, silicon-oxide-nitride-oxide-silicon (SONOS) memory, resistive RAM (RRAM), domain-wall memory (DWM), nano-RAM, floating junction gate RAM (FJG RAM), memristor memory, spin-transfer torque RAM (STT-RAM), as well as other memory devices/modules that maintain stored information across power cycles (e.g., off/on). Non-volatile memory that stores data across a power cycle may also be referred to as a persistent data memory.

In some examples, the non-volatile memory correspond to a class of non-volatile memory which is referred to as storage class memory (SCM). In these examples, the SCM non-volatile memory is byte-addressable, synchronous with a processing resource, and in a processing resource coherent domain. Moreover, SCM non-volatile memory may comprise types of memory having relatively higher read/write speeds as compared to other types of non-volatile memory, such as hard-drives or magnetic tape memory devices. Examples of SCM non-volatile memory include some types of flash memory, RRAM, memristors. PCM, MRAM, STT-RAM, as well as other types of higher read/write speed persistent data memory devices. As will be appreciated, due to relatively low read and write speeds of some types of non-volatile memory, such as spin-disk hard drives, NAND flash, magnetic tape drives, processing resources may not directly process instructions and data with these types of non-volatile memory. However, a processing resource may process instructions and data directly with a SCM non-volatile memory. Therefore, as will be appreciated, in examples in which a non-volatile memory is used to store a system memory, sensitive data may remain in the non-volatile memory across a power cycle.

As used herein, a memory resource may comprise one device and/or module or a combination devices and/or modules. Furthermore, a memory device/module may comprise various components. For example, a volatile memory corresponding to a dynamic random-access memory (DRAM) module may comprise a plurality of DRAM integrated circuits, a memory controller, a capacitor, and/or other such components mounted on a printed circuit board. Similarly, a non-volatile memory may comprise a plurality of memory circuits, a memory controller, and/or other such components. In examples described herein, a memory resource may comprise a combination of volatile and/or non-volatile memory modules/devices.

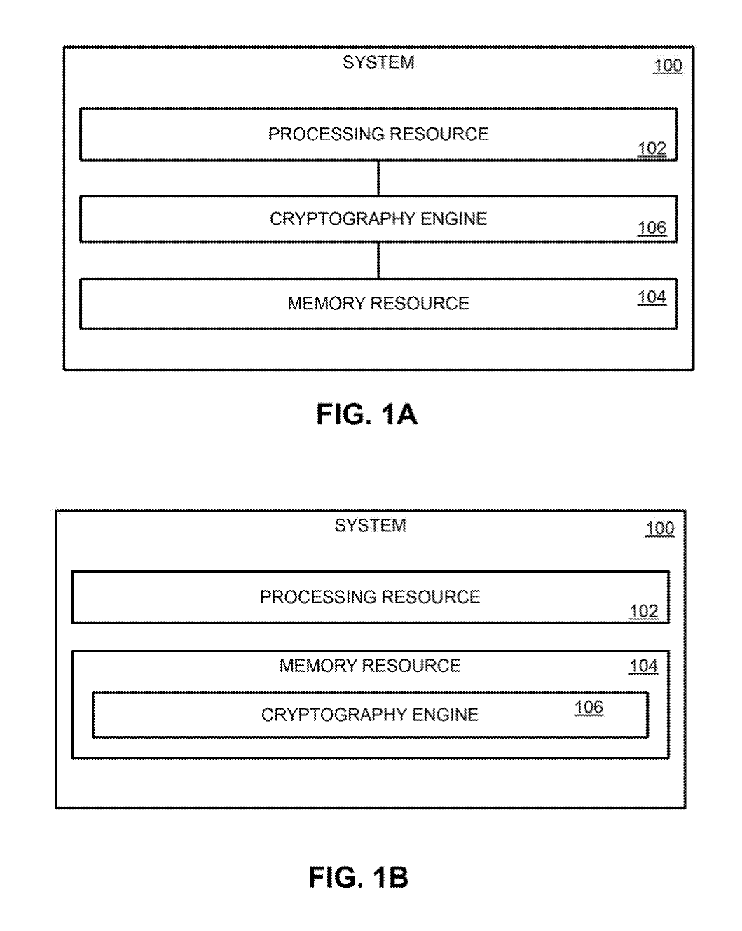

Turning now to the figures, and particularly to FIGS. 1A and 1B, these figures provide block diagrams that illustrate examples of a system 100. Examples of a system as disclosed herein include a personal computer, a portable electronic device (e.g., a smart phone, a tablet, a laptop, a wearable device, etc.), a workstation, a smart device, server, a processing node of a server, a data center comprising a plurality of servers, and/or any other such data processing devices. In the examples, the system 100 comprises a processing resource 102, a memory resource 104, and a cryptography engine 106 that is in-line with the memory resource 104 and the processing resource 102.

As discussed, in examples such as the example system 100 of FIGS. 1A and 1B, the cryptography engine 106 may selectively decrypt data during read accesses of the memory resource 104 by the processing resource 102. In addition, in some examples, the cryptography engine 106 may selectively encrypt data during write accesses of the memory resource 104 by the processing resource 102. Therefore, during some memory accesses of the memory resource 104 by the processing resource 102 (e.g., to read or write data), the cryptography engine 106 may encrypt or decrypt data communicated therebetween. Similarly, during some accesses of the memory resource 104 by the processing resource 102, the cryptography engine 106 may not encrypt or decrypt data; instead, in these examples, the cryptography engine 106 may read or write data without encryption or decryption. In the example of FIG. 1A, the cryptography engine 106 is illustrated as a separate component connected between the processing resource 102 and the memory resource 104. In the example of FIG. 1B, the cryptography engine 106 is illustrated as a component of the memory resource 104. As will be appreciated, the cryptography engine 106 being arranged in-line with the processing resource 102 and the memory resource 104 includes the example arrangements of the cryptography engine 106 illustrated in FIGS. 1A and 1B. Furthermore, the memory resource 104 may comprise memory modules, and in such examples, the system 100 may comprise a cryptography engine coupled to and forming a part/component of each memory module. For example, a cryptography engine may be embedded in each respective memory module.

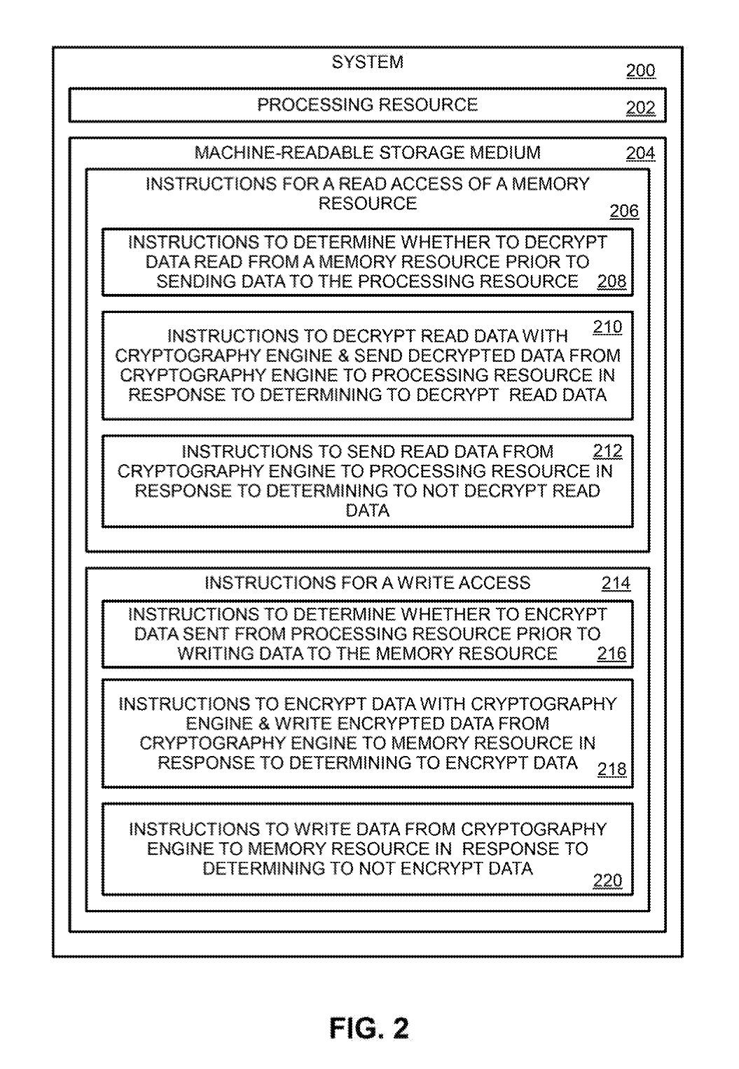

FIG. 2 provides a block diagram that illustrates an example system 200. In this example, the system 200 comprises at least one processing resource 202 and a machine readable storage medium 204. The machine-readable storage medium 204 may represent the random access memory (RAM) devices or other similar memory devices comprising the main storage of the example system 200, as well as any supplemental levels of memory, e.g., cache memories, non-volatile or backup memories (e.g., programmable or flash memories), read-only memories, etc. In addition, machine-readable storage medium 204 may be considered to include memory storage physically located elsewhere, e.g., any cache memory in a microprocessor, as well as any storage capacity used as a virtual memory, e.g., as stored on a mass storage device or on another system in communication with the example system 200.

Furthermore, the machine-readable storage medium 204 may be non-transitory. In some examples, the machine-readable storage medium 204 may be a compact disk, blu-ray disk, or other such types of removable media. In some examples, the processing resource 202 and machine-readable storage medium 204 may correspond to processing units and memory devices arranged in at least one server. In other examples, the processing resource 202 and machine-readable storage medium may be arranged in a system-on-a-chip device. In some examples, the processing resource 202 and machine-readable storage medium may be arranged in a portable computing device, such as laptop, smart phone, tablet computer, etc.

In addition, the machine-readable storage medium 204 may be encoded with and/or store instructions that may be executable by the processing resource 202, where execution of such instructions may cause the processing resource 202 and/or system 200 to perform the functionalities, processes, and/or sequences of operations described herein. In the example of FIG. 2, the machine-readable storage medium 204 comprises instructions for a read access of a memory resource 206. As shown, for a read access of a memory resource 206, the machine-readable storage medium 204 comprises instructions to determine whether to decrypt data read from the memory resource prior to sending data to the processing resource 208. In addition, for a read access of a memory resource 206, the machine-readable storage medium 204 comprises instructions to decrypt data read from the memory resource with the cryptography engine and send decrypted data from the cryptography engine to the processing resource in response to determining to decrypt the read data 210. Furthermore, for a read access of a memory resource, the machine-readable storage medium 204 comprises instructions to send data from the cryptography engine to the processing resource in response to determining not to decrypt read data 212.

Moreover, the machine-readable storage medium 204 comprises instructions for a write access 214. The instructions for a write access 214 include instructions to determine whether to encrypt data sent from the processing resource prior to writing the data to the memory resource 216. Furthermore, for a write access 214, the machine-readable storage medium comprises instructions to encrypt data with the cryptography engine and write the encrypted data from the cryptography engine to the memory resource in response to determining to encrypt the data 218. In addition, for a write access 214, the machine-readable storage medium 204 comprises instructions to write data from the cryptography engine to the memory resource in response to determining to not encrypt the data 220.

While not shown in FIGS. 1A, 1B, and 2, for interface with a user or operator, some example systems may include a user interface incorporating one or more user input/output devices, e.g., one or more buttons, a display, a touchscreen, a speaker, etc. The user interface may therefore communicate data to the processing resource and receive data from the processing resource. For example, a user may input one or more selections via the user interface, and the processing resource may cause data to be output on a screen or other output device of the user interface. Furthermore, the system may comprise a network interface device. As will be appreciated, the network interface device comprises one or more hardware devices to communicate data over one or more communication networks, such as a network interface card. In addition, the system may comprise applications, processes, and/or operating systems stored in a memory resource. The applications, processes, ad/or operating systems may be executed by the system such that the processing resource processes instructions of the applications, processes, and/or operating systems with the system memory stored in the memory resource.

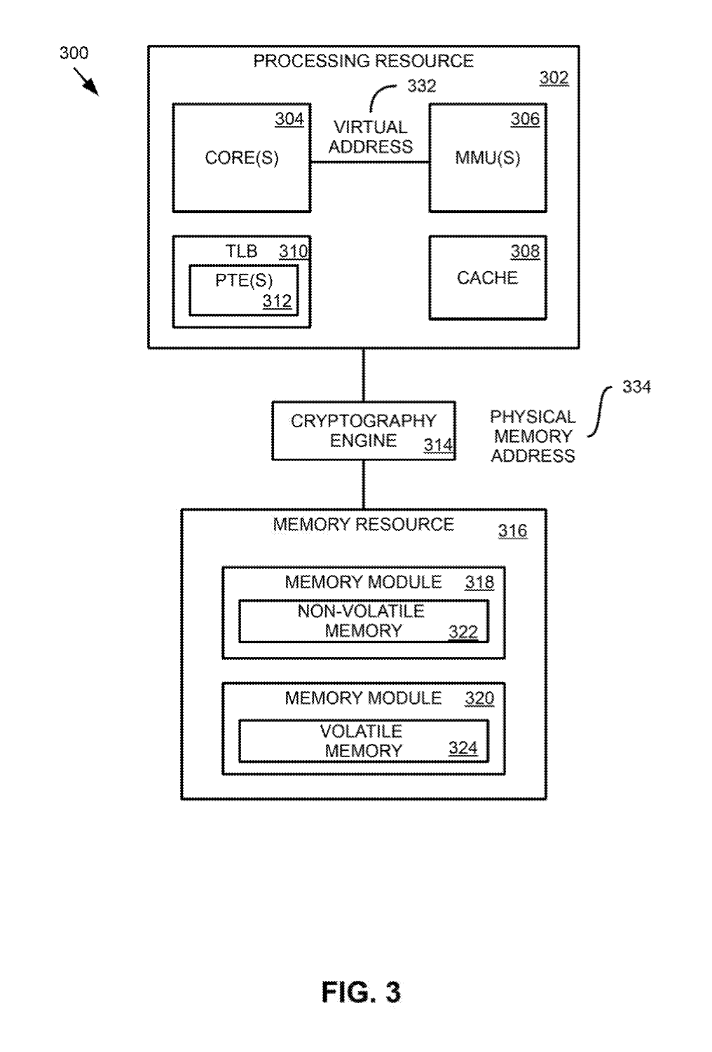

FIG. 3 provides a block diagram that illustrates some components of an example system 300. As discussed, in some examples, a processing resource comprises a central processing unit (CPU) that includes at least one processing core. In this example, the system 300 comprises a processing resource 302 that includes at least one core 304. In some examples, the processing resource 302 may comprise one core 304, and in other examples the CPU 302 may comprise two cores 304 (referred to as a dual-core configuration), four cores (referred to as a quad-core configuration), etc. As will be appreciated, in an example system implemented as a server, the system may comprise hundreds or even thousands of cores 304. As shown, the processing resource 302 further comprises at least one memory management unit (MMU) 306. In some examples, the processing resource 302 comprises at least one MMU 306 for each core 304. In addition, in this example, the processing resource comprises cache memory 308, where the cache memory 308 may comprise one or more cache memory levels that may be used for storing decoded instructions, fetched/read data, and results. Furthermore, the processing resource 302 comprises at least one translation look-aside buffer (TLB) 310 that includes page table entries (PTEs) 312.

A translation look-aside buffer may correspond to a cache specially purposed for facilitating virtual address translation. In particular the TLB stores page table entries that map virtual addresses to an intermediate addresses and/or physical memory addresses. A memory management unit 306 may search a TLB with a virtual address to determine a corresponding intermediate address and/or physical memory address. A TLB is limited in size, such that not all necessary PTEs may be stored in the TLB. Therefore, in some examples additional PTEs may be stored in other areas of memory, such as a volatile memory and/or a non-volatile memory. As will be appreciated, the TLB represents a very high-speed memory location, such that address translations performed based on data stored in a TLB will be faster than translations performed with PTEs located elsewhere.

In this example, the processing resource 302 is connected to a cryptography engine 314, and in turn, the cryptography engine 314 is connected to a memory resource 316. In this example, the memory resource 316 comprises a first memory module 318 and a second memory module 320. The first memory module 318 includes non-volatile memory 322, and the second memory module 320 includes a volatile memory module 324.

While not shown in the example, the non-volatile memory 322 may comprise a portion associated with read-only memory (ROM) and a portion associated with storage. A system memory may be stored in the volatile memory 320 and/or the non-volatile memory 322. In examples similar to the example of FIG. 3, data to be written to the memory resource during a write access may be stored in the cache 308 and transmitted from the processing resource 302 to the memory resource 316 via the cryptography engine 314. The cryptography engine 314 may selectively encrypt data received from the processing resource 302 prior to writing the data to the memory resource 316. Similarly, data retrieved from the memory resource 316 during a read access of the memory resource 316 may be transmitted to the processing resource 302 via the cryptography engine 314. The cryptography engine 314 may selectively decrypt data read from the memory resource 316 prior to transmitting the data to the cache 308 of the processing resource 302.

As will be appreciated, the cores 304 of the processing resource 302 perform operations to implement an instruction cycle, which may also be referred to as the fetch-decode-execute cycle. As used herein, processing instructions may refer to performing the fetching, decoding, and/or execution of instructions and associated data. During the instruction cycle, the processing resource 302 decodes instructions to be executed, where the decoded instructions include memory addresses for data upon which operations of the instruction are to be performed (referred to as source operands) as well as memory addresses where results of performing such operations are to be stored (referred to as target operands). As will be appreciated, the memory addresses of decoded instructions are virtual addresses. Moreover, a virtual address may refer to a location of a virtual address space that may be assigned to a process/application. A virtual address is not directly connected to a particular memory location of a memory device (such as the volatile memory 324 or non-volatile memory 322). A virtual address space may also be referred to as a process address space. Consequently, when preparing to execute an instruction, a core 304 may communicate a virtual address to an associated MMU 306 for translation to a physical memory address such that data stored at the physical memory address 334 may be fetched for execution. A physical memory address may be directly related to a particular physical memory location (such as a particular location of the volatile memory 324 and/or non-volatile memory 322). Therefore, as shown in FIG. 3, at the core 304 level, memory addresses correspond virtual addresses 332.

The MMU 306 translates a virtual address 332 to a physical memory address 334 based on a mapping of virtual addresses to physical memory addresses that may be stored in one or more page table entries 312. As will be appreciated, in this example, the processing resource 302 includes a TLB 310 that stores page table entries 312 with which the MMU 306 may translate a virtual address. In the example implementation illustrated in FIG. 3, the memory resource 316 comprises both volatile memory 324 and the non-volatile memory 322.

In examples similar to the example of FIG. 3, the system 300 may translate a virtual address 332 that is associated with the system memory 328 to a physical memory address 334 of the volatile memory 320 or the non-volatile memory 322. As will be appreciated, during processing of instructions by the cores 304, data may be read from the memory resource 316 and written to the memory resource 316. In examples such as the example of FIG. 3, the cryptography engine selectively encrypts/decrypts data transmitted between the processing resource 302 and the memory resource 316.

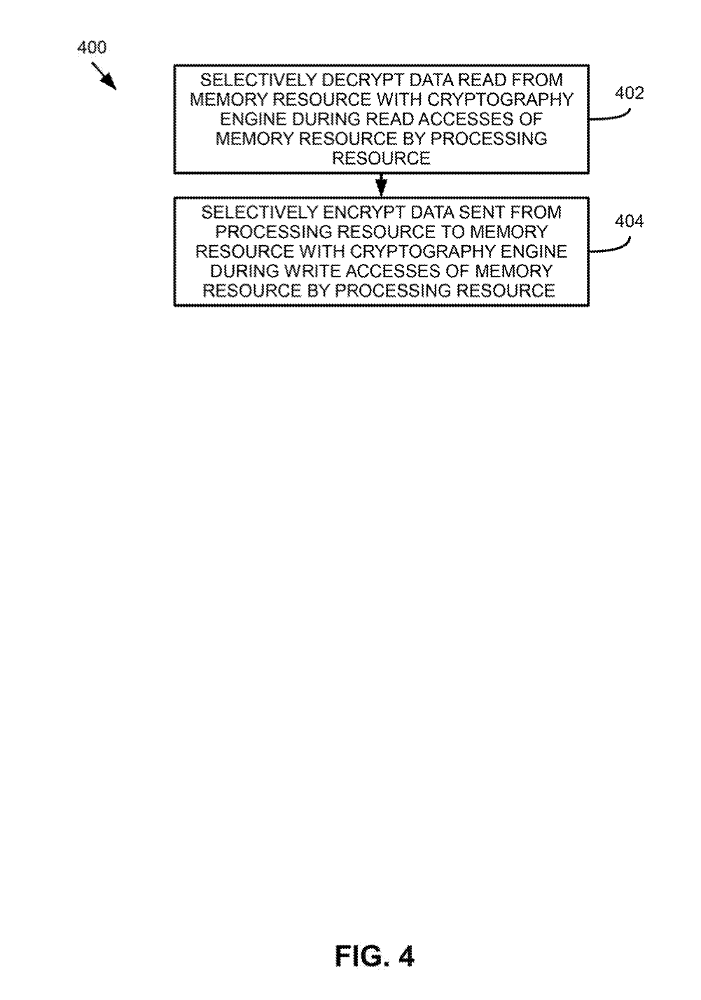

FIGS. 4-7 provide flowcharts that provide example sequences of operations that may be performed by an example system and/or a processing resource thereof to perform example processes and methods. In some examples, the operations included in the flowcharts may be embodied in a memory resource (such as the example machine-readable storage medium 204 of FIG. 2) in the form of instructions that may be executable by a processing resource to cause the system (e.g., the system 100 of FIGS. 1A-B, the system 200 of FIG. 2) to perform the operations corresponding to the instructions. Additionally, the examples provided in FIGS. 4-7 may be embodied in systems, machine-readable storage mediums, processes, and/or methods. In some examples, the example processes and/or methods disclosed in the flowcharts of FIGS. 4-7 may be performed by one or more engines implemented in a system.

FIG. 4 provides a flowchart 400 that illustrates an example sequence of operations that may be performed by an example system. In this example, the system selectively decrypts data read from a memory resource with a cryptography engine during read accesses of the memory resource by a processing resource (block 402). Furthermore, the system selectively encrypts data sent from the processing resource to the memory resource with the cryptography engine during write accesses of the memory resource by the processing resource (block 404).

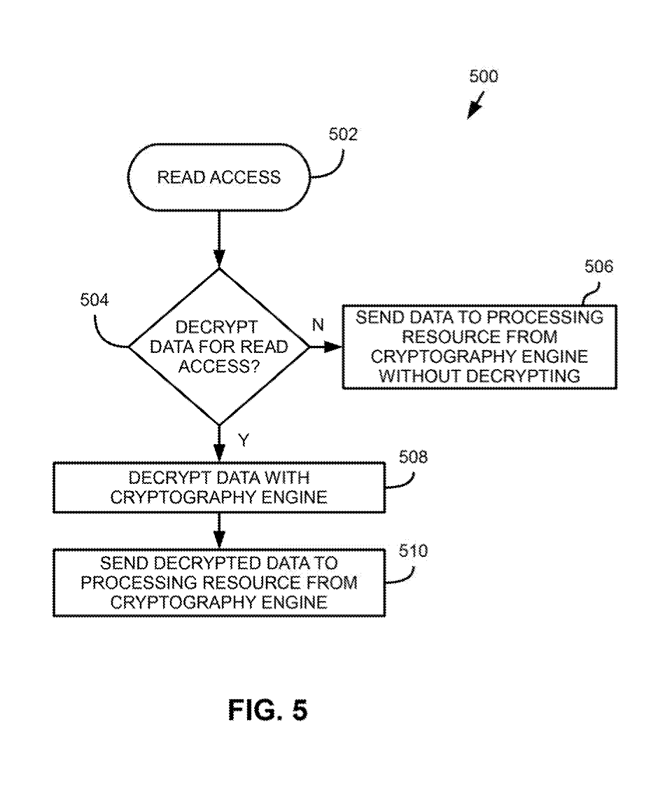

Turning now to FIG. 5, this figure provides a flowchart 500 that illustrates an example sequence of operations that may be performed by an example system. As discussed previously, the system may selectively decrypt data for read accesses of a memory resource by a processing resource. Accordingly in this example, for a particular read access (block 502), the system determines whether to decrypt data for the particular read access (block 504). In response to determining to not decrypt the data for the particular read access (“N” branch of block 504), the system sends the read data to the processing resource from the cryptography engine without decrypting the data (block 506). In response to determining to decrypt the data for the particular read access (“Y” branch of block 504), the system decrypts the data with the cryptography engine (block 508), and the system sends the decrypted data to the processing resource from the cryptography engine (block 510). Therefore, based on the example of FIG. 5, it will be appreciated that the system may operate on data differently for different read accesses. For example, for a first read access, the system may decrypt data retrieved from the memory resource with the cryptography engine prior to sending the data to the processing resource. For a second read access, the system may not decrypt data retrieved from the memory resource, and the cryptography engine may send the data to the processing resource without performing decryption.

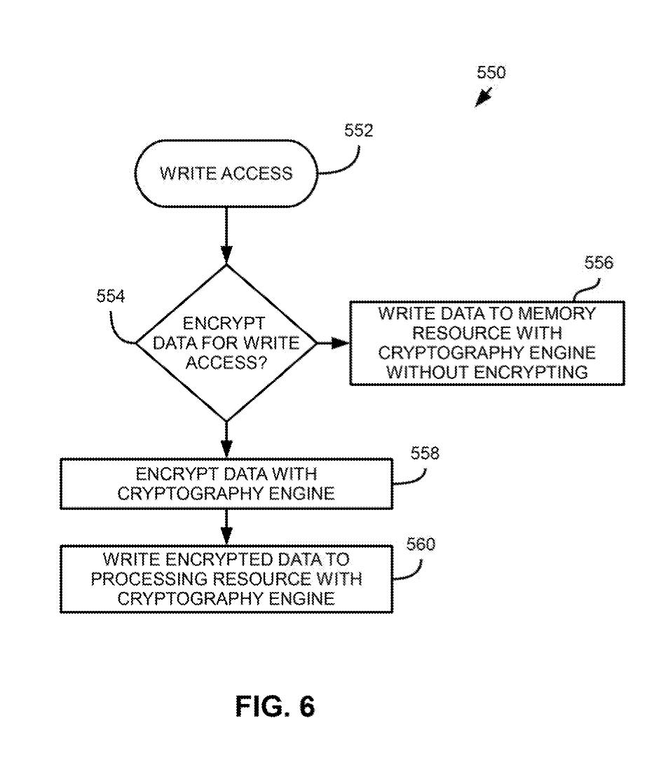

FIG. 6 provides a flowchart 550 that illustrates an example sequence of operations that may be performed by an example system. As discussed previously, the system may selectively encrypt data for write accesses of a memory resource by a processing resource. Accordingly in this example, for a particular write access (block 552), the system determines whether to encrypt data for the particular write access (block 554). In response to determining to not encrypt the data for the particular write access (“N” branch of block 554), the system writes the data to the memory resource with the cryptography engine without decrypting the data (block 556). In response to determining to encrypt the data for the particular write access (“Y” branch of block 554), the system encrypts the data with the cryptography engine (block 558), and the system writes the encrypted data to the memory resource from the cryptography engine (block 560). Therefore, based on the example of FIG. 6, it will be appreciated that the system may operate on data differently for different write accesses. For example, for a first write access, the system may encrypt data received from the processing resource with the cryptography engine prior to writing the data to the memory resource. For a second write access, the system may not encrypt data received from the processing resource, and the cryptography engine may write the data to the memory resource without performing encryption.

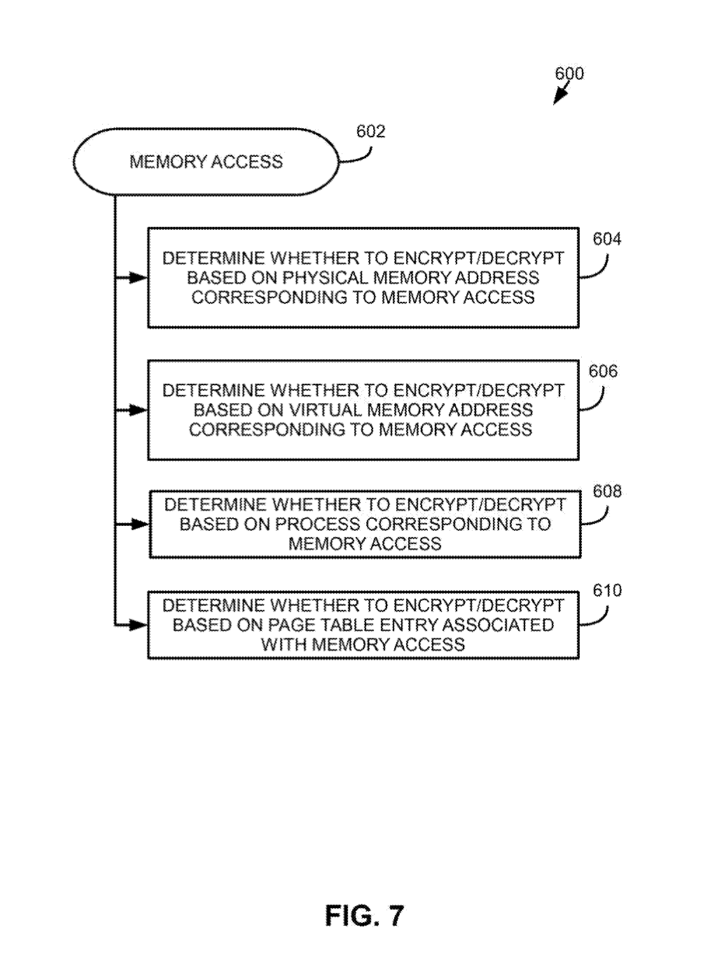

FIG. 7 provides a flowchart 600 that illustrates an example sequence of operations that may be performed by an example system. Example systems may determine whether to encrypt/decrypt data for a particular memory access based at least in part on the data to be read/written. For example, for a memory access (block 602), the system may determine whether to encrypt/decrypt data based at least in part on a physical memory address corresponding to the memory access (block 604). Therefore in this example, when accessing the memory location corresponding to the physical memory address, the system determines whether to encrypt/decrypt data based on the physical memory address. For example, for a first read access associated with a first physical memory address, the system may determine to decrypt data retrieved from the first physical memory address. For a second read access associated with a second physical memory address, the system may determine to not decrypt data retrieved from the second physical memory address.

Furthermore, in some examples, for a memory access (block 602), a system may determine whether to encrypt/decrypt data based at least in part on a virtual memory address corresponding to the memory access (block 606). For example, for a first write access associated with a first virtual memory address, the system may determine to encrypt data to be written to the memory resource. As another example, for a second write access associated with a second virtual memory address, the system may determine to not encrypt data to be written to the memory resource.

In some examples, for a memory access (block 602), the system may determine whether to encrypt/decrypt data based at least in part on a process corresponding to the memory access (block 608). As discussed, examples may access physical memory locations of a memory resource when processing instructions with a processing resource. Furthermore, the instructions processed by the processing resource may correspond to at least one process that may be executing with the processing resource. In examples similar to the example of FIG. 6, the process that causes a memory access during execution thereof may effect whether the system encrypts/decrypts data associated with the process. As will be appreciated, some data operated on and/or generated by a process may be sensitive data. In some example systems an operating system and/or a kernel of such operating system may indicate to the cryptography engine whether data to be read or written for a process is to be encrypted/decrypted.

In some examples, for a memory access (block 602), the system may determine whether to encrypt/decrypt data based at least in part on a page table entry associated with the memory access (block 610). As discussed previously, in some examples, page table entries may be implemented at the processing resource to facilitate mapping of virtual addresses to physical memory addresses. In some examples, a page table entry may further indicate whether data associated with a virtual address and/or a physical memory address is sensitive. In such examples, the page table entry associated with a particular virtual address and/or physical memory address may indicate whether data to be read from or written thereto are to be encrypted or decrypted.

As will be appreciated, in some example systems, determining whether to encrypt data for a particular write access may be based at least in part a combination of the examples provided in FIG. 7. Similarly, determining whether to decrypt data for a particular read access may be based at least in part on a combination of the examples provided in FIG. 7.

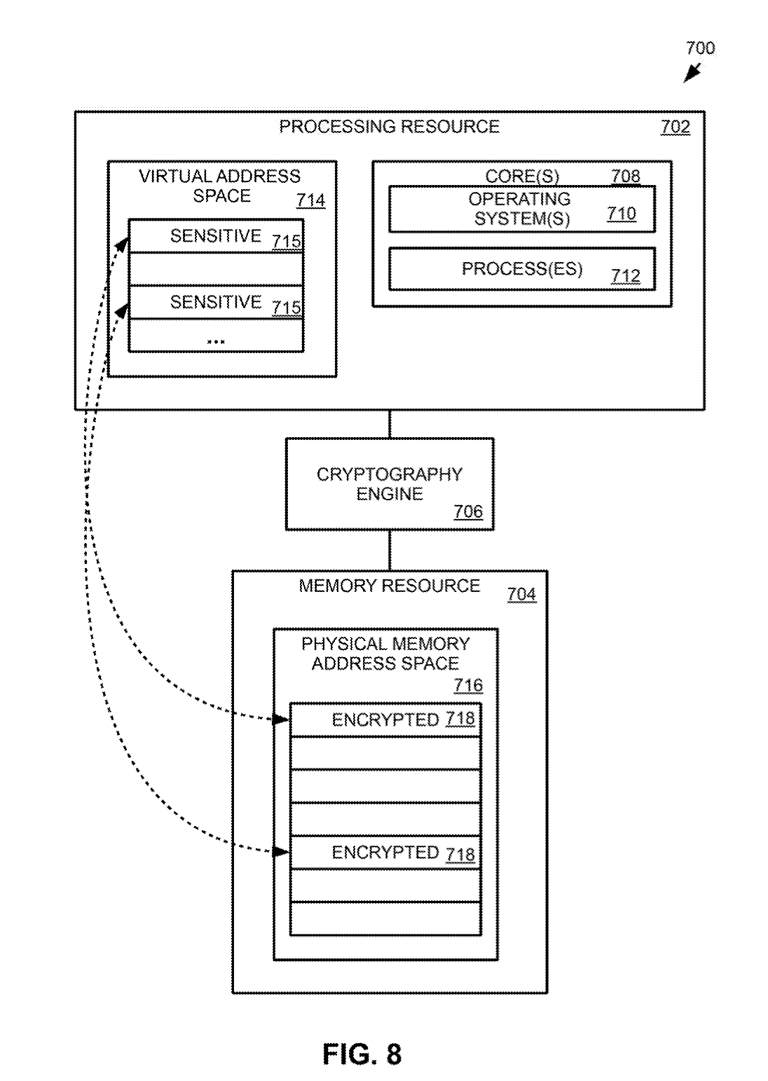

FIGS. 8A and 8B provide block diagrams that illustrate example operations of some components of an example system 700. In the examples, the system 700 comprises a processing resource 702 and a memory resource 704. In addition, the system 700 includes a cryptography engine 706 in-line with the processing resource 702 and the memory resource 704. As described in previous examples, the processing resource 702 comprises at least one core 708, and, as shown, the at least one core 708 may execute at least one operating system 710 and at least one process 712. As shown, a virtual address space 714 is implemented at the processing resource 702 level. As will be appreciated, the virtual address space 714 may be implemented with a cache, translation look-aside buffer, and/or a memory management unit. In the example shown in FIG. 8, the virtual address space 714 may include sensitive pages 715 (i.e., virtual blocks of sensitive data). Furthermore, the memory resource 704 includes a physical memory address space 716 implemented by at least one memory module. As shown, the sensitive pages 715 of the virtual address space 714 may correspond to encrypted pages 718 (i.e., encrypted blocks of data) stored in the memory resource 704. In the examples of FIGS. 8A and 8B, when processing instructions for the at least one process 712, for a read access, the cryptography engine 706 may decrypt data stored in the encrypted pages 718 of the memory resource prior to sending the data to the processing resource 702. Similarly, for a write access, the cryptography engine 706 may encrypt the sensitive data 715 prior to writing the data to the memory resource 704.

As discussed previously, in some examples, the cryptography engine may determine to decrypt data stored at a physical memory address of the memory resource 704 based at least in part on the physical memory address. For example, the operating system 710 or a kernel thereof may indicate to the cryptography engine 706 that data at a particular physical memory address is encrypted, such that decryption may be performed prior to sending such data to the processing resource 702. As another example, data stored in a page table entry of a translation look-aside buffer may indicate that data of a particular virtual address is sensitive, such that the operating system 710 or a kernel thereof may indicate to the cryptography engine 706 that data associated with the particular virtual address is to be encrypted prior to writing the data to the memory resource 704. In other examples, the operating system 710 and/or a kernel thereof may directly indicate whether data is sensitive/encrypted for corresponding memory accesses based on a process for which the data is retrieved or generated.

In the example of FIG. 8B, a portion of the physical memory address space 716 may be allocated 730 for storing encrypted data at the operating system 710 and/or kernel level. Accordingly, in FIG. 8B, the system encrypts all data to be written to the physical memory addresses allocated for storing encrypted data, and the system decrypts all data read from the physical memory addresses allocated for storing encrypted data. In contrast, the system does not encrypt data to be written to a physical memory address that is not allocated for storing encrypted data, and the system does not decrypt data read from a physical memory address that is not allocated for storing encrypted data.

Therefore, examples of systems, processes, methods, and/or computer program products implemented as executable instructions stored on a non-transitory machine-readable storage medium described herein may selectively decrypt data read from a memory resource with an in-line cryptography engine prior to sending the data to a processing resource. In addition, examples may selectively encrypt data to be written to a memory resource with an in-line cryptography engine prior to writing the data to the memory resource. As will be appreciated, implementation of examples described herein may facilitate secure data storage in memory resources, where such data security may be implemented in-line with the processing resources and memory resources of a system.

In addition, while various examples are described herein, elements and/or combinations of elements may be combined and/or removed for various examples contemplated hereby. For example, the example operations provided herein in the flowcharts of FIGS. 4-7 may be performed sequentially, concurrently, or in a different order. Moreover, some example operations of the flowcharts may be added to other flowcharts, and/or some example operations may be removed from flowcharts. Furthermore, in some examples, various components of the example systems of FIGS. 1A, 1B, and 2 may be removed, and/or other components may be added. Similarly, in some examples various instructions of the example memories and/or machine-readable storage mediums of FIG. 2 may be removed, and/or other instructions may be added (such as instructions corresponding to the example operations of FIGS. 4-7).

The preceding description has been presented to illustrate and describe examples of the principles described. This description is not intended to be exhaustive or to limit examples to any precise form disclosed. Many modifications and variations are possible in light of this description.

1. A system comprising:
a processing resource;
a memory resource; and
a cryptography engine arranged in-line with the memory resource and the processing resource, the cryptography engine to selectively decrypt data during read accesses of the memory resource by the processing resource.

2. The system of claim 1, wherein the cryptography engine to selectively decrypt data during read accesses of the memory resource comprises the cryptography engine to:
for a respective read access of the memory, determine whether to decrypt data read from the memory resource prior to sending the data to the processing resource.

3. The system of claim 2, wherein the cryptography engine to determines whether to decrypt data read from the memory resource prior to sending the data to the processing resource based at least in part on a physical memory address corresponding to the respective read access, a virtual memory address corresponding to the respective read access, a respective process corresponding to the respective read access, a page table entry associated with the respective read access, or any combination thereof.

4. The system of claim 1, wherein the cryptography engine to selectively decrypt data during read accesses of the memory resource by the processing resource comprises the cryptography engine to:
for a first read access of the memory resource by the processing resource:
decrypt data read from the memory resource,
send the decrypted data to the processing resource; and
for a second read access of the memory resource by the processing resource, send the data to the processing resource without decrypting the data.

5. The system of claim 1, wherein the cryptography engine is further to:
selectively encrypt data during write accesses of the memory resource by the processing resource.

6. The system of claim 5, wherein the cryptography engine to selectively encrypt data during write accesses of the memory resource by the processing resource comprises the cryptography engine to:
for a respective read access of the memory, determine whether to encrypt data to be written to the memory resource prior to writing the data to the memory resource.

7. The system of claim 6, wherein the cryptography engine to determine whether to encrypt data to be written to the memory resource prior to sending the data to the memory resource based at least in part on a physical memory address corresponding to the respective write access, a virtual memory address corresponding to the respective write access, a respective process corresponding to the respective write access, a page table entry associated with the respective write access, or any combination thereof.

8. The system of claim 5, wherein the cryptography engine to selectively encrypt data during write accesses of the memory resource by the processing resource comprises the cryptography engine to:
for a first write access of the memory resource by the processing resource:
encrypt data sent from the processing resource,
write the encrypted data to the memory resource; and
for a second write access of the memory resource by the processing resource, write data sent from the processing resource to the memory resource without encrypting the data.

9. The system of claim 1, further comprising:
a memory management unit connected between the processing resource and the cryptography engine,
wherein the cryptography engine is a component of the memory resource.

10. A method for a system that comprises a processing resource, a memory resource, and a cryptography engine arranged in-line with the processing resource and the memory resource, the method comprising:
during read accesses of the memory resource by the processing resource, selectively decrypting data read from the memory resource with the cryptography engine, and
during write accesses of the memory resource by the processing resource, selectively encrypting data sent from the processing resource to the memory resource with the cryptography engine.

11. The method of claim 10, wherein selectively decrypting data read from the memory resource comprises:
for a first read access, decrypting read data with the cryptography engine, and sending the decrypted data to the processing resource from the cryptography engine, and
for a second read access, sending read data to the processing resource from the cryptography engine without decrypting the data.

12. The method of claim 10, wherein selectively encrypting data sent from the processing resource to the memory resource comprises:
for a first write access:
encrypting sent data with the cryptography engine,
writing the encrypted data to the memory resource with the cryptography engine, and
for a second write access, writing data received from the processing resource to the memory resource with the cryptography engine without encrypting the data.

13. The method of claim 10, wherein data is selectively decrypted and selectively encrypted based at least in part on a physical memory address corresponding to a respective access, a virtual memory address corresponding to the respective access, a respective process corresponding to the respective access, a page table entry associated with the respective access, or any combination thereof.

14. A non-transitory machine-readable storage medium comprising instructions executable by a processing resource of a system to cause the system to:
for a read access of a memory resource:
determine whether to decrypt data read from the memory resource prior to sending the read data to the processing resource;
in response to determining to decrypt the read data, decrypt the read data with a cryptography engine, send the decrypted data from the cryptography engine to the processing resource;
in response to determining to not decrypt the read data, send the read data from the cryptography engine to the processing resource; and
for a write access of the memory resource:
determine whether to encrypt data sent from the processing resource prior to writing the data to the memory resource;
in response to determining to encrypt the data prior to writing the data, encrypt the data with the cryptography engine, and write the encrypted data to the memory resource;
in response to determining to not encrypt the data prior to writing the data, write the data to the memory resource with the cryptography engine.

15. The non-transitory machine-readable storage medium of claim 14, wherein whether to decrypt data is determined based at least in part on a physical memory address corresponding to the respective read access, a virtual memory address corresponding to the respective read access, a respective process corresponding to the respective read access, a page table entry associated with the respective read access, or any combination thereof, and
wherein whether to encrypt data is determined based at least in part on a physical memory address corresponding to the respective write access, a virtual memory address corresponding to the respective write access, a respective process corresponding to the respective write access, a page table entry associated with the respective write access, or any combination thereof.
